(19) United States
(12) Patent Application Publication
(10) Pub. No.: US 2026/0175270 A1
(43) Pub. Date: Jun. 25, 2026

(54) PROCESSES FOR DISPLACING PARTICULATE MATTER FROM LOW FLOW AND SMALL CLEARANCE AREAS IN ROTATING EQUIPMENT

(71) Applicant: UOP LLC, Des Plaines, IL (US)

(72) Inventors: Aziz Sattar, Itasca, IL (US); Anh Ngo, Cypress, TX (US); Michael R. Van de Cotte, Palatine, IL (US); Jeffrey Tyska, Roselle, IL (US)

(21) Appl. No.: 19/337,239

(22) Filed: Sep. 23, 2025

Related U.S. Application Data
(60) Provisional application No. 63/736,873, filed on Dec. 20, 2024.

(51) Int. Cl. B08B 9/00; B01D 53/04; B01D 53/14; B01D 53/22

(52) U.S. Cl. CPC B08B 9/00; B01D 53/0423; B01D 53/0446; B01D 53/1425; B01D 53/1475; B01D 53/229; B01D 2256/10; B01D 2257/504; B01D 2258/0283

(57) ABSTRACT

Processes for displacing particulates from low flow and small clearance areas in rotating equipment associated with a carbon capture unit, the process comprising compressing, in a compressor, a flue gas stream to provide a compressed flue gas stream; processing, in a CO₂ separation zone in a carbon capture unit, the compressed flue gas stream and providing a CO₂ enriched stream and an evacuation gas stream; and introducing the evacuation gas stream to rotating equipment to displace any particulates in low flow and small clearance areas in the rotating equipment.

### RELATED APPLICATIONS

This application claims priority to United States Provisional Patent Application Ser. No. 63/736,873, filed on December 20, 2024, the entire disclosure of which is incorporated herein by reference.

### FIELD OF THE INVENTION

This invention relates generally to processes for displacing particulates from low flow and small clearance areas in a rotating equipment, such as compressors and expanders, associated with a carbon capture unit.

### BACKGROUND OF THE INVENTION

A recurring issue in treatment of flue gas is particulate matter deposits. Flue gas contains particulate matter which may deposit on rotating and static surfaces in equipment. This is a problem particularly in low flow and small clearance areas in rotating equipment.

Particulate deposits may harden, which reduces the design gap between adjacent components within the rotating equipment leading to additional friction impacting performance of equipment such ability to deliver required pressure and/or flow and/or more power draw on drivers and/or higher the planned discharge temperatures. The deposition of the particulate matter may also introduce unbalanced mass to rotating equipment leading to vibration and eventual failure of equipment. Finally, the deposition material may foul heat exchanger surfaces leading to reduction in thermal performance and/or increase in pressure drop.

Of particular concern is the feed compressor of a carbon capture unit as it the first rotating equipment to process flue gas with uncaptured particulate matter. The feed compressor may be one of the highest priced pieces of equipment in the plant and may have the greatest influence of plant reliability and uptime. Additionally, any particulate matter that is not removed from the feed compressor will pass downstream to other equipment in the carbon capture unit, including heat exchangers and cryogenic carbon capture zones. The heat exchanger may be shell and tube type as well as plate fin heat exchangers. Plate fin type have small passages that are difficult to clean if fouled. Plate fin type exchangers may have brazed/welded construction and cannot be disassembled for cleaning access.

Carbon capture units also contain other types of rotating equipment which process flue gas having uncaptured particulate matter, such as expanders. Expanders are often used in carbon capture units for energy or power recovery. As described herein, a concern is that any particulate matter that is deposited on the expander may result in fouling of equipment, which reduces the lifetime of the equipment. Additionally, any particulate matter which is not removed from the rotating equipment may be passed further downstream to other equipment in the carbon capture unit, or may be vented to the atmosphere.

Accordingly, it would be desirable to have more effective and efficient ways to increase the performance and longevity of rotating equipment associated with carbon capture units by suppressing the deposit, and subsequent hardening, of particulate deposits in low flow and small clearance areas in rotating equipment.

### SUMMARY OF THE INVENTION

The present inventors have discovered developed processes for displacing particulates from low flow and small clearance areas in rotating equipment associated with a carbon capture unit. The processes described herein may be modifications to existing carbon capture units for capturing CO₂ from flue gas that have associated rotating equipment.

Therefore, the present invention may be characterized, in at least one aspect, as providing a process for displacing particulates from low flow and small clearance areas in a rotating equipment associated with a carbon capture unit by compressing, in a compressor, a flue gas stream to provide a compressed flue gas stream; processing, in a CO₂ separation zone in a carbon capture unit, the compressed flue gas stream and providing a CO₂ enriched stream and an evacuation gas stream; and introducing the evacuation gas stream to the rotating equipment to displace any particulates in low flow and small clearance areas in the rotating equipment.

The CO₂ separation zone may be selected from a group consisting of a pressure swing adsorption (PSA) CO₂ separation zone, a temperature swing adsorption (TSA) CO₂ separation zone, a cryogenic CO₂separation zone, a solvent-based CO₂ separation zone, a membrane-based CO₂ separation zone, or a combination of any one or more of the foregoing.

The process may include filtering the evacuation gas stream.

The process may include compressing the evacuation gas stream.

The rotating equipment may be selected from a group consisting of a compressor, an expander, or a combination of any one or more of the foregoing.

The process may include heating the evacuation gas stream. The evacuation gas stream may be heated to a temperature higher than a dewpoint of the flue gas stream.

The CO₂ separation zone may further provide an N₂ enriched stream, wherein the evacuation gas stream includes at least a portion of the N₂ enriched stream.

The evacuation gas stream may include at least a portion of the CO₂ enriched stream.

The process may include drying the CO₂ enriched stream to remove H₂O and providing a dried CO₂ enriched stream, wherein the evacuation gas stream includes at least a portion of the dried CO₂ enriched stream.

The evacuation gas stream may be selected from a group consisting of CO₂, N₂, CO, O₂, H₂O (g), Ar, He, or a combination of any one or more of the foregoing.

The present invention may be also characterized, in at least another aspect, as providing a process for displacing particulates from low flow and small clearance areas in rotating equipment associated with a carbon capture unit by compressing, in a compressor, a flue gas stream to provide a compressed flue gas stream; sorbing, in a CO₂ separation zone including one or more vessels containing sorbent in a carbon capture unit, the compressed flue gas stream and providing a CO₂ enriched stream and an evacuation gas stream; and introducing the evacuation gas stream to the rotating equipment to displace any particulates in low flow and small clearance areas in the rotating equipment.

The one or more vessels may be distillation columns including solid adsorbent.

The evacuation gas stream may include at least a portion of the CO₂ enriched stream.

The evacuation gas stream may be a CO₂ depleted stream or N₂ enriched stream.

The one or more columns may be stripper columns including solvent absorbent.

The rotating equipment may be selected from a group consisting of a compressor, an expander, or a combination of any one or more of the foregoing.

The present invention may be further characterized, in at least another aspect, as providing a process for displacing particulates from low flow and small clearance areas in rotating equipment associated with a carbon capture unit by compressing, in a compressor, a flue gas stream to provide a compressed flue gas stream; processing, in a membrane-based CO₂ separation zone including one or more membranes in a carbon capture unit, the compressed flue gas stream and providing a CO₂ enriched permeate stream and an evacuation gas stream; and introducing the evacuation gas stream to the rotating equipment to displace any particulates in low flow and small clearance areas in the rotating equipment.

The evacuation gas stream may include at least a portion of the CO₂ enriched permeate stream.

The rotating equipment may be selected from a group consisting of a compressor, an expander, or a combination of any one or more of the foregoing.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

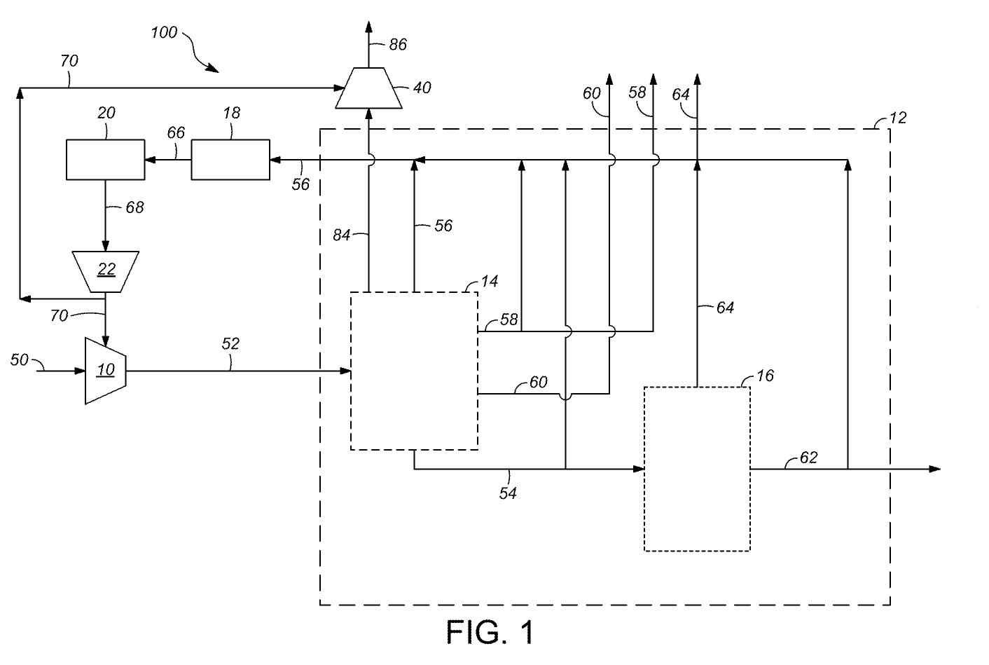

FIG. 1 shows a schematic depiction of a system according to one or more aspects of the present invention.

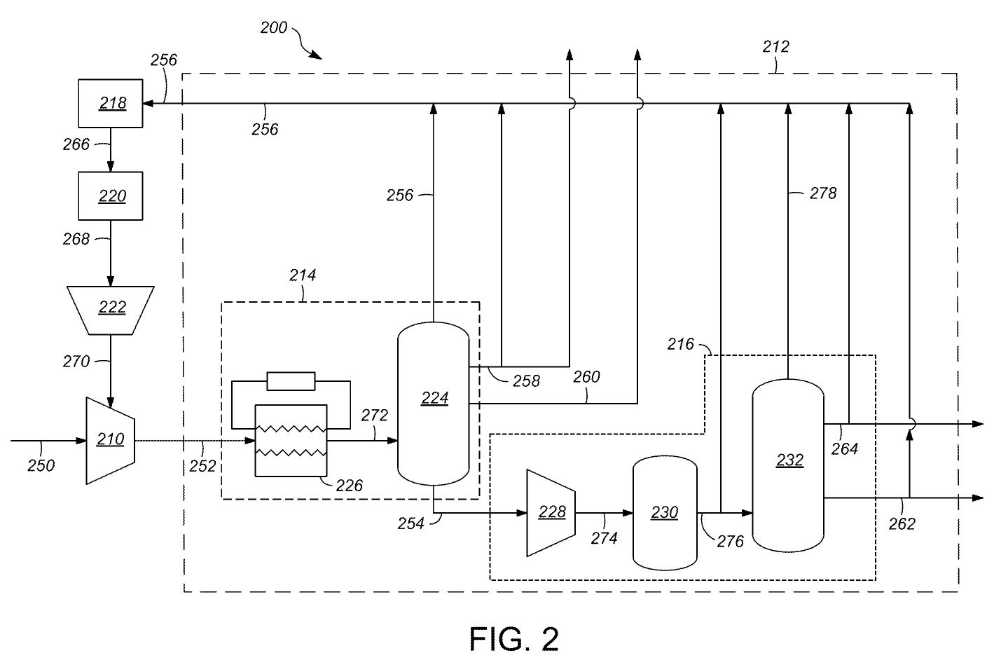

FIG. 2 shows a schematic depiction of a system according to one or more aspects of the present invention.

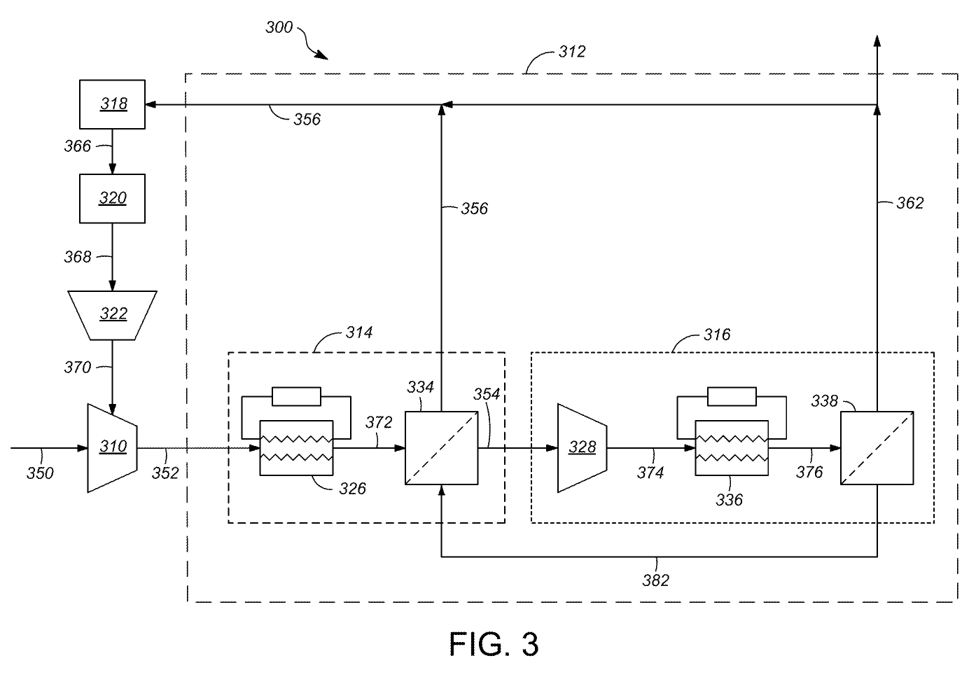

FIG. 3 shows a schematic depiction of a system according to one or more aspects of the present invention.

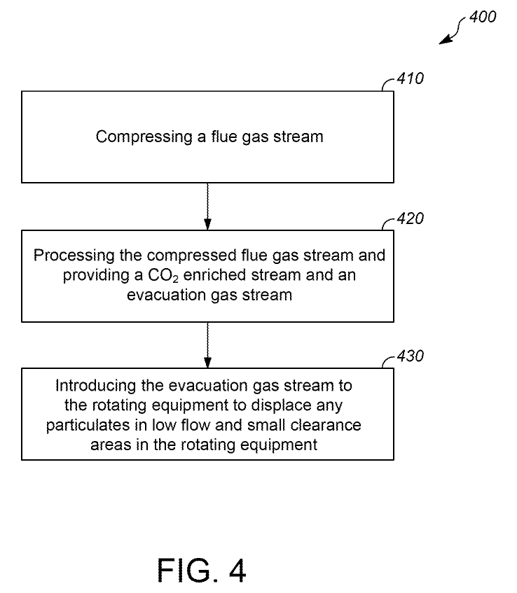

FIG. 4 shows a process flow diagram according to one or more aspects of the present invention.

It should be appreciated and understood by those of ordinary skill in the art that various other components such as valves, pumps, etc. were not shown in the drawings as it is believed that the specifics of same are well within the knowledge of those of ordinary skill in the art and a description of same is not necessary for practicing or understating the embodiments of the present invention.

### DETAILED DESCRIPTION OF THE INVENTION

As mentioned above, processes for displacing particulates from low flow and small clearance areas in rotating equipment associated with a carbon capture unit have been invented. The processes described herein may be modifications to existing carbon capture units for capturing CO₂ from flue gas that have associated rotating equipment. In particular, described herein are processes for displacing particulates from low flow and small clearance areas in rotating equipment associated with a carbon capture unit that captures CO₂ enriched product streams from flue gas streams.

By “CO₂ enriched” it is meant that the stream contains at least 50% CO₂, at least 90% CO₂, or at least 95% CO₂. Similarly, as used herein, by “N₂ enriched” it is meant that the stream contains at least 50% N₂, at least 90% N₂, or at least 95% N₂. What is meant by “flue gas streams” are process gas streams containing CO₂, N₂, CO, and O₂, small portions (i.e., less than 1%) of H₂O (g), Ar, He, other impurities, including particulates and corrosive gases (e.g., H₂S, SO₂), or a combination of any one or more of the foregoing. In some embodiments, flue gas streams comprise about 59% N₂, 18% CO₂, 13% H₂O, 9% O₂, and less than 1% of H₂O (g), Ar, He, and other impurities. What is meant by “evacuation gas streams” are process gas streams containing CO₂, N₂, CO, O₂, H₂O (g), Ar, He, or a combination of any one or more of the foregoing. In some embodiments, evacuation gas streams are CO₂ depleted gas streams or lean flue gas streams produced by a CO₂ separation zone in a carbon capture unit, as described herein. What is meant by “CO₂ depleted gas streams” or “lean flue gas streams” are process gas streams which have been processed to reduce or remove CO₂ and contain less than 25%, less than 10%, or less than 5% CO₂.

In some embodiments, an evacuation gas stream contains 10 to 100 vol% CO₂, 0 to 90 vol% N₂, 0 to 15 vol% O₂, 0 to 3 vol% Ar, and 0 to 3000 ppm CO. In some embodiments, an evacuation gas stream contains 4 to 50 vol% CO₂, 0 to 90 vol% N₂, 0 to 15 vol% O_{2,}0 to 3 vol% Ar, and 0 to 3000 ppm CO. In some embodiments, an evacuation gas stream contains 0.1 to 100 vol% CO₂, 0 to 90 vol% N₂, and 0 to 15 vol% O₂, 0 to 3 vol% Ar, and 0 to 3000 ppm CO.

With these general principles in mind, one or more embodiments of the present invention will be described with the understanding that the following description is not intended to be limiting.

Turning to FIGS. 1 to 4, various embodiments of the present invention will be described which are utilized to displace particulates from low flow and small clearance areas in rotating equipment associated with a carbon capture unit.

Turning to FIG. 1, an exemplary system 100 for implementing processes for displacing particulates from low flow and small clearance areas rotating equipment associated with a carbon capture unit is shown. System 100 may include a first compressor 10 associated with a carbon capture unit 12. Carbon capture unit 12 may include CO₂ separation zone 14 and carbon capture zone 16, as described in more detail herein. System 100 may include a filter 18, a heater 20, a second compressor 22, and an expander 40. Although specific components are shown in FIG. 1 as being included in system 100, system 100 may include more or fewer components. For example, system 100 may include a plurality of filters 18 in order to effectively remove particular contaminants from a process stream. System 100 may also integrate or separate various components shown in FIG. 1.

Filter 18 may filter contaminants present in an evacuation gas stream, as described in more detail herein. In some embodiments, filter 18 may be a fiberglass filter, a pleated filter, a high-efficiency particulate air (HEPA) filter, an electrostatic filter, coalescing filter, an activated carbon filter, or a combination of one or more of the foregoing.

Heater 20 may heat an evacuation gas stream, as described in more detail herein. Heater 20 may be a flanged heater, a circulation heater, an over-the-side heater, a screw-plug heater, a duct heater, a pipe heater, a line heater, or a combination of one or more of the foregoing. In some embodiments, heater 20 may be a heat exchanger. A heat exchanger may be a double-pipe heat exchanger, a shell-and-tube heat exchanger, a plate heat exchanger, an adiabatic wheel heat exchanger, a plate fin heat exchanger, a finned tube heat exchanger, a phase change heat exchanger, a waste heat recovery unit, a direct contact heat exchanger, or a combination of one or more of the foregoing.

First compressor 10 and second compressor 22 may compress a stream to a predetermined pressure. In some embodiments, first compressor 10 and second compressor 22 may be a centrifugal compressor, an axial compressor, a reciprocating air compressor, a rotary screw compressor, a rotary vane air compressor, a rotary screw air compressor, or a combination of one or more of the foregoing.

Expander 40 may expand a stream to a predetermined pressure. In some embodiments, expander 40 may recover power or energy from system 100. In some embodiments expander 40, also known as a turboexpander, may be a radial turbine, an axial flow turbine, or a combination of one or more of the foregoing.

Still referring to FIG. 1, as described in more detail herein, CO₂ separation zone 14 may process a compressed flue gas stream and provide at least a CO₂ enriched stream and an evacuation gas stream. In some embodiments, evacuation gas stream may be a CO₂ depleted gas stream. CO₂ separation zone 14 may also optionally produce an N₂ enriched stream, an O₂ enriched stream, and a residue gas stream. In some embodiments, CO₂ separation zone 14 is a pressure swing adsorption (PSA) CO₂ separation zone, a temperature swing adsorption (TSA) CO₂ separation zone, a solvent-based CO₂ separation zone, a membrane-based CO₂ separation zone, or a combination of any one or more of the foregoing. CO₂ separation zone 14 may include auxiliary components (e.g., pump, valve, heating/cooling elements, and so forth)

Carbon capture zone 16 may process a CO₂ enriched stream and provide at least a CO₂ enriched product stream and optionally an N₂ enriched byproduct stream. The type of carbon capture technology used in carbon capture zone 16 is not particularly limited and may be of any type that is capable of providing at least a CO₂ enriched product stream and optionally an N₂ enriched byproduct stream. In some embodiments, carbon capture zone 16 may be, but is not limited to, a PSA zone, a cryogenic PSA zone, or a membrane separation zone, or a combination of any one or more of the foregoing. In some embodiments, the CO₂ enriched product stream leaving the carbon capture zone 16 is a cryogenic liquid.

Still referring to FIG. 1, system 100 may be used in a process for displacing particulates from low flow and small clearance areas rotating equipment associated with a carbon capture unit 12. In some embodiments, the rotating equipment is a first compressor 10, an expander 40, or a combination thereof. In this embodiment, a flue gas stream 50 may be passed to first compressor 10 to compress flue gas stream 50 to a predetermined pressure to provide to provide a compressed flue gas stream 52. The compressed flue gas stream 52 may be passed to carbon capture unit 12. In carbon capture unit 12, compressed flue gas stream 52 may be passed to CO₂ separation zone 14 to provide at least CO₂ enriched stream 54 and evacuation gas 56. CO₂ separation zone 14 may also optionally produce N₂ enriched stream 58, O₂ enriched stream 60, and residue gas stream 84. The residue gas stream 84 may be passed to an expander 40 to provide an expanded residue gas stream 86 to be vented to the atmosphere. In some embodiments, residue gas stream 84 is a CO₂ depleted gas stream. The CO₂ enriched stream 54 may be passed to carbon capture zone 16 to provide at least CO₂ enriched product stream 62 and N₂ enriched byproduct stream 64.

Without being bound by theory, it is speculated that depending on the physical properties, flow rate, and so forth, of the evacuation gas stream 56, evacuation gas stream 56 may need to be treated or processed before it is passed to rotating equipment in order to effectively displace particulates from low flow and small clearance areas in the rotating equipment. Thus, in some embodiments, the evacuation gas stream 56 may be filtered, heated, compressed, depressurized, or a combination of one or more of the foregoing. Still referring to FIG. 1, the evacuation gas stream 56 may be passed to filter 18 to provide a filtered evacuation gas stream 66. Filtered evacuation gas stream 66 may be passed to heater 20 to provide a heated evacuation gas stream 68. Heated evacuation gas stream 68 may be passed to second compressor 22 to compress heated evacuation gas stream 68 to a predetermined pressure to provide compressed evacuation gas stream 70. Alternatively, depending on the pressure of heated evacuation gas stream 68, heated evacuation gas stream 68 may instead be passed to a valve (not shown) to depressurize the heated evacuation gas stream 68. Compressed evacuation gas stream 70 may be passed to rotating equipment to displace particulates from low flow and small clearance areas in first rotating equipment . In the specific embodiment shown in FIG. 1, compressed evacuation gas stream 70 may be passed to first compressor 10 to displace particulates from low flow and small clearance areas in first compressor 10. Alternatively, or additionally, compressed evacuation gas stream 70 may be passed to expander 40 to displace particulates from low flow and small clearance areas in expander 40.

While FIG. 1 shows a specific embodiment where the evacuation gas stream first enters filter 18, then heater 20, and second compressor heater 22, other arrangements are contemplated. For example, evacuation gas stream 56 may first be passed to heater 20, then filter 18, and finally second compressor 22, or may first be passed to second compressor 22, then filter 18, and finally heater 20, or evacuation gas stream 56 may first be passed to heater 20, then a valve (not shown), and then to filter 18, and so forth.

As shown in FIG. 1, evacuation gas 56 may include at least a portion of process streams provided by various components in system 100. In some embodiments, evacuation gas stream 56 may include at least a portion of N₂ enriched stream 58, CO₂ enriched stream 54, N₂ enriched byproduct stream 64, CO₂ enriched stream product stream 62, and combinations of one or more of the foregoing.

In some embodiments, evacuation gas stream 56 is filtered such that a d99 of the filtered evacuation gas stream 66 is 1 µm. In some embodiments, evacuation gas stream 56 is filtered such that a d99 of the filtered evacuation gas stream 66 is 0.5 µm. In other embodiments, the filtered evacuation 66 gas stream is heated to a temperature higher than a dewpoint of the flue gas stream 50. In some embodiments, the heated evacuation gas stream 68 is compressed to a pressure at least 0.1 psi greater than the flue gas stream 50. In some embodiments, the heated evacuation gas stream 68 is compressed to a pressure at least 1 psi greater than the flue gas stream 50. In some embodiments, the heated evacuation gas stream 68 is compressed to a pressure at least 5 psi greater than the flue gas stream 50.

Turning now to FIG. 2, an exemplary system 200 is provided that may be used in a process for displacing particulates from low flow and small clearance areas in first compressor 210 associated with a carbon capture unit 212. In system 200, CO₂ separation zone 214 may include one or more vessel 224 including sorbent. In some embodiments, CO₂ separation zone 214 may include a plurality of vessels 224, which are cycled through various stages of adsorption and desorption, as is well-known in the art. In some embodiments, system 200 may include a sorbent regeneration zone (not shown) in connection with one or more vessel 224. In some embodiments, the sorbent is solid adsorbent. In other embodiments, the sorbent is solvent absorbent. In embodiments where the sorbent is solid adsorbent, one or more vessel 224 may be a distillation column. In embodiments where the sorbent is solvent absorbent, one or more vessel 224 may be a stripper.

Types of sorbents that may be used as the solid adsorbent include, but is not limited to alumina, silica, molecular sieve, or a combination of any one or more of the foregoing. Types of solvents that may be used as the solvent absorbent include, but is not limited to, phase-change solvents, amine solvents, ammonia, carbonate solvents, water-lean solvents, and combinations thereof. Amine solvents may include, but is not limited to, primary amines (e.g., monoethanolamine or MEA, 2-(2-aminoethoxy) ethanol), secondary amines (e.g., diethanolamine or DEA, diisopropanolamine or DIPA), and tertiary amines (e.g., methyldiethanolamine or MDEA, triethylamine or TEA), or a combination of any one or more of the foregoing. Carbonate solvents include, but is not limited to, potassium carbonate, sodium carbonate, dimethyl carbonate, or a combination of any one or more of the foregoing.

In some embodiments, CO₂ separation zone 214 may include cooling element 226. Cooling element 226 may be used to cool a compressed flue gas stream to a predetermined temperature. Cooling element 226 may be a heat exchanger or a cooler. A heat exchanger may be of the type described herein. A cooler may be a heat sink cooler, a heat pipe cooler, a vapor compression cooler, a thermoelectric cooler, or a combination of one or more of the foregoing.

Still referring to FIG. 2, system 200 may include carbon capture zone 216. In the exemplary system 200, carbon capture zone 216 is a cryogenic PSA zone including a third compressor 228, dryer 230, and distillation column 232. Third compressor 228 may be of the type described herein. Dryer 230 may be selected from alumina, silica gel, molecular sieves, or a combination of one or more of the foregoing. In some embodiments, carbon capture zone 216 may include a heater (not shown). As described in more detail herein, evacuation gas may need to be processed or treated before it is passed to first compressor 210 in order to effectively displace particulates from low flow and small clearance areas in first compressor 210. Thus, system 200 may also include filter 218, heater 220, and second compressor 230. Filter 218 may be of the type as described herein. Heater 220 may be of the type as described herein. Second compressor 230 may be of the type as described herein.

System 200 may be used in a process for displacing particulates from low flow and small clearance areas in first compressor 210 associated with a carbon capture unit 212. In this embodiment, flue gas 250 may be passed to first compressor 210 to compress flue gas stream 250 to a predetermined pressure. The compressed flue gas stream 252 may be passed to cooling element 226 to be cooled to a predetermined temperature. The predetermined temperature may be based on the type of sorbent included in one or more vessel 224, the type of zone used in CO₂ separation zone 214 (i.e., TSA, PSA, solvent-based), or both. The cooled flue gas stream 272 may be passed to one or more vessel 224 to provide CO₂ enriched stream 254 and evacuation gas stream 256. CO₂ separation zone 214 may also optionally produce N₂ enriched stream 258 and O₂ enriched stream 260.

As shown in FIG. 2, CO₂ enriched stream 254 may be passed to third compressor 228 to compress CO₂ enriched stream 254 to a predetermined pressure. Compressed CO₂ enriched stream 274 may be passed to dryer 230 to remove H₂O and provide a dried CO₂ enriched stream 276 and optionally an H₂O stream (not shown). Dried CO₂ enriched stream 276 may be passed to distillation column 232 to provide at least CO₂ enriched product stream 262, N₂ enriched byproduct stream 264, and vent gas stream 278. In some embodiments, dried CO₂ enriched stream 276 may be passed to a heater (not shown) to provide a heated dried enriched stream (not shown) before being passed to distillation column 232.

As described in more detail herein, evacuation gas stream 256 may need to be treated or processed before it is passed to first compressor 210 in order to effectively displace particulates from low flow and small clearance areas in first compressor 210. Thus, evacuation gas stream 256 may be passed to filter 218 to provide a filtered evacuation gas stream 266. Filtered evacuation gas stream 266 may be passed to heater 220 to provide a heated evacuation gas stream 268. Heated evacuation gas stream 268 may be passed to second compressor 222 to compress heated evacuation gas stream 268 to a predetermined pressure and provide compressed evacuation gas stream 270. Compressed evacuation gas stream 270 may be passed to first compressor 210 to displace particulates from low flow and small clearance areas in first compressor 210.

As shown in FIG. 2, evacuation gas 256 may include at least a portion of process streams provided by various components in system 200. In some embodiments, evacuation gas stream 256 may include at least a portion of N₂ enriched stream 258, dried CO₂ enriched stream 278, N₂ enriched byproduct stream 264, CO₂ enriched stream product stream 262, and combinations of one or more of the foregoing.

Turning now to FIG. 3, another exemplary system 300 is provided that may be used in a process for displacing particulates from low flow and small clearance areas in first compressor 310 associated with a carbon capture unit 312. In system 300, CO₂ separation zone 314 may include a cooling element 326 and one or more first membrane 334. In some embodiments, CO₂ separation zone 314 may include a plurality of membranes 334, depending on the concentration of contaminants in the flue gas stream.

The one or more first membrane 334 may be a polymeric membrane (e.g., glassy polymer membranes, polymers of intrinsic microporosity (PIMs) membranes, thermally rearranged (TR) polymer membranes, rubbery polymer membranes), an ionic liquid (IL) membrane, an inorganic membrane (e.g., ceramic membranes, organic-inorganic composite membranes, carbon membranes), or combinations of one or more of the foregoing.

In some embodiments, CO₂ separation zone 314 may include first cooling element 326. First cooling element 326 may be used to cool a compressed flue gas stream to a predetermined temperature. First cooling element 326 may be a heat exchanger or a cooler. A heat exchanger may be of the type described herein. A cooler also may be of the type described herein.

Still referring to FIG. 3, system 300 may include carbon capture zone 316. In the exemplary system 300, carbon capture zone 316 is a membrane separation zone including a third compressor 328, second cooling element 336, and at least one second membrane 338. Third compressor 328 may be of the type described herein. Second cooling element 336 may be of the type described herein. At least one second membrane 338 may be of the type described herein. In some embodiments, CO₂ separation zone 314 may include a plurality of membranes 338. As described in more detail herein, evacuation gas may need to be processed or treated before it is passed to first compressor 310 in order to effectively displace particulates from low flow and small clearance areas in first compressor 310. Thus, system 300 may also include filter 318, heater 320, and second compressor 330.

System 300 may be used in a process for displacing particulates from low flow and small clearance areas in first compressor 310 associated with a carbon capture unit 312. In this embodiment, flue gas 350 may be passed to first compressor 310 to compress flue gas stream 350 to a predetermined pressure. The compressed flue gas stream 352 may be passed to first cooling element 326 to be cooled to a predetermined temperature. The predetermined temperature may be based on the type of membrane used as the at least one first membrane 334. The cooled flue gas stream 372 may be passed to at least at least one first membrane 334 to provide CO₂ enriched stream 354 and evacuation gas 356. In this embodiment, evacuation gas 356 is flue gas retentate stream and CO₂ enriched stream 354 is a CO₂ enriched permeate stream.

As shown in FIG. 3, CO₂ enriched stream 354 may be passed to third compressor 328 to compress CO₂ enriched stream 354 to a predetermined pressure. Compressed CO₂ enriched stream 374 may be passed to second cooling element 336 to cool compressed CO₂ enriched stream 374 to a predetermined temperature. The predetermined temperature may be based on the type of membrane used as the at least one second membrane 338. Cooled CO₂ enriched stream 376 may be passed to at least one second membrane 338 to provide at least CO₂ enriched product stream 362 and recycle gas stream 382. In this embodiment, recycle gas stream 382 is a CO₂ depleted retentate stream and CO₂ enriched product stream 362 is a CO₂ enriched permeate stream.

As described in more detail herein, evacuation gas stream 356 may need to be treated or processed before it is passed to first compressor 310 in order to effectively displace particulates from low flow and small clearance areas in first compressor 310. Thus, evacuation gas stream 356 may be passed to filter 318 to provide a filtered evacuation gas stream 366. Filtered evacuation gas stream 366 may be passed to heater 320 to provide a heated evacuation gas stream 368. Heated evacuation gas stream 268 may be passed to second compressor 322 to compress heated evacuation gas stream 368 to a predetermined pressure and provide compressed evacuation gas stream 370. Compressed evacuation gas stream 370 may be passed to first compressor 310 to displace particulates from low flow and small clearance areas in first compressor 310.

As shown in FIG. 3, evacuation gas 356 may include at least a portion of process streams provided by various components in system 300. In some embodiments, evacuation gas stream 356 may include at least a portion of recycled gas stream 382, at least a portion of CO₂ enriched stream product stream 362, and combinations of one or more of the foregoing.

Turning now to FIG. 4, an exemplary process 400 for displacing particulates from low flow and small clearance areas in rotating equipment associated with a carbon capture unit. The process 400 may include additional steps, may integrate or combine steps, or a combination of the foregoing. The process 400 may include any one or more steps described with reference to the systems in FIGS. 1-3. The process 400 may be implemented using any one or more of the systems in FIGS. 1-3.

Process 400 may begin at step 410, a step of compressing a flue gas stream. The process 400 may include a step 420 of processing the compressed flue gas stream and providing a CO₂ enriched stream and an evacuation gas stream. In step 430, the process 400 may include a step of introducing the evacuation gas stream to the rotating equipment to displace any particulates in low flow and small clearance areas in the rotating equipment.

The systems described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be utilized to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps.

For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

### SPECIFIC EMBODIMENTS

While the following is described in conjunction with specific embodiments, it will be understood that this description is intended to illustrate and not limit the scope of the preceding description and the appended claims.

A first embodiment of the invention is a process for displacing particulates from low flow and small clearance areas in rotating equipment associated with a carbon capture unit, the process comprising compressing, in a compressor, a flue gas stream to provide a compressed flue gas stream; processing, in a CO₂ separation zone in a carbon capture unit, the compressed flue gas stream and providing a CO₂ enriched stream and an evacuation gas stream; and introducing the evacuation gas stream to rotating equipment to displace any particulates in low flow and small clearance areas in the rotating equipment. An embodiment of the invention is one, any or all of prior embodiments in this paragraph up through the first embodiment in this paragraph, wherein the CO₂ separation zone is selected from a group consisting of a pressure swing adsorption (PSA) CO₂ separation zone, a temperature swing adsorption (TSA) CO₂ separation zone, a solvent-based CO₂ separation zone, a membrane-based CO₂ separation zone, or a combination of any one or more of the foregoing. An embodiment of the invention is one, any or all of prior embodiments in this paragraph up through the first embodiment in this paragraph, wherein the process further comprises filtering the evacuation gas stream. An embodiment of the invention is one, any or all of prior embodiments in this paragraph up through the first embodiment in this paragraph, wherein the process further comprises compressing the evacuation gas stream. An embodiment of the invention is one, any or all of prior embodiments in this paragraph up through the first embodiment in this paragraph, wherein the rotating equipment is selected from a group consisting of a compressor, an expander, or a combination of any one or more of the foregoing. An embodiment of the invention is one, any or all of prior embodiments in this paragraph up through the first embodiment in this paragraph, wherein the process further comprises heating the evacuation gas stream. An embodiment of the invention is one, any or all of prior embodiments in this paragraph up through the first embodiment in this paragraph, wherein the evacuation gas stream is heated to a temperature higher than a dewpoint of the flue gas stream. An embodiment of the invention is one, any or all of prior embodiments in this paragraph up through the first embodiment in this paragraph, the CO₂ separation zone further providing an N₂ enriched stream, wherein the evacuation gas stream includes at least a portion of the N₂ enriched stream. An embodiment of the invention is one, any or all of prior embodiments in this paragraph up through the first embodiment in this paragraph, wherein the evacuation gas stream includes at least a portion of the CO₂ enriched stream. An embodiment of the invention is one, any or all of prior embodiments in this paragraph up through the first embodiment in this paragraph, further comprising drying the CO₂ enriched stream to remove H₂O and providing a dried CO₂ enriched stream, wherein the evacuation gas stream includes at least a portion of the dried CO₂ enriched stream. An embodiment of the invention is one, any or all of prior embodiments in this paragraph up through the first embodiment in this paragraph, wherein the evacuation gas stream is selected from a group consisting of CO₂, N₂, CO, O₂, H₂O (g), Ar, He, or a combination of any one or more of the foregoing.

A second embodiment of the invention is a process for displacing particulates from low flow and small clearance areas in rotating equipment associated with a carbon capture unit, the process comprising compressing, in a compressor, a flue gas stream to provide a compressed flue gas stream; sorbing, in a CO₂ separation zone including one or more vessels containing sorbent in a carbon capture unit, the compressed flue gas stream and providing a CO₂ enriched stream and an evacuation gas stream; and introducing the evacuation gas stream to rotating equipment to displace any particulates in low flow and small clearance areas in the rotating equipment. An embodiment of the invention is one, any or all of prior embodiments in this paragraph up through the second embodiment in this paragraph, wherein the one or more vessels are distillation columns including solid adsorbent. An embodiment of the invention is one, any or all of prior embodiments in this paragraph up through the second embodiment in this paragraph, wherein the evacuation gas stream includes at least a portion of the CO₂ enriched stream. An embodiment of the invention is one, any or all of prior embodiments in this paragraph up through the second embodiment in this paragraph, wherein the evacuation gas stream is a CO₂ depleted stream or N₂ enriched stream. An embodiment of the invention is one, any or all of prior embodiments in this paragraph up through the second embodiment in this paragraph, wherein the one or more vessels are stripper columns regenerating solvent. An embodiment of the invention is one, any or all of prior embodiments in this paragraph up through the second embodiment in this paragraph, wherein the rotating equipment is selected from a group consisting of a compressor, an expander, or a combination of any one or more of the foregoing.

A third embodiment of the invention is a process for displacing particulates from low flow and small clearance areas in rotating equipment associated with a carbon capture unit, the process comprising compressing, in a compressor, a flue gas stream to provide a compressed flue gas stream; processing, in a membrane-based CO₂ separation zone including one or more membranes in a carbon capture unit, the compressed flue gas stream and providing a CO₂ enriched permeate stream and an evacuation gas stream; and introducing the evacuation gas stream to rotating equipment to displace any particulates in low flow and small clearance areas in the rotating equipment. An embodiment of the invention is one, any or all of prior embodiments in this paragraph up through the third embodiment in this paragraph, wherein the evacuation gas stream includes at least a portion of the CO₂ enriched permeate stream. An embodiment of the invention is one, any or all of prior embodiments in this paragraph up through the third embodiment in this paragraph, wherein the rotating equipment is selected from a group consisting of a compressor, an expander, or a combination of any one or more of the foregoing.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for displacing particulates from low flow and small clearance areas in rotating equipment associated with a carbon capture unit, the process comprising:
compressing, in a compressor, a flue gas stream to provide a compressed flue gas stream;
processing, in a CO₂ separation zone in a carbon capture unit, the compressed flue gas stream and providing a CO₂ enriched stream and an evacuation gas stream; and
introducing the evacuation gas stream to rotating equipment to displace any particulates in low flow and small clearance areas in the rotating equipment.

2. The process of claim 1, wherein the CO₂ separation zone is selected from a group consisting of a pressure swing adsorption (PSA) CO₂ separation zone, a temperature swing adsorption (TSA) CO₂ separation zone, a solvent-based CO₂ separation zone, a membrane-based CO₂ separation zone, or a combination of any one or more of the foregoing.

3. The process of claim 1, wherein the process further comprises filtering the evacuation gas stream.

4. The process of claim 1, wherein the process further comprises compressing the evacuation gas stream.

5. The process of claim 1, wherein the rotating equipment is selected from a group consisting of a compressor, an expander, or a combination of any one or more of the foregoing.

6. The process of claim 1, wherein the process further comprises heating the evacuation gas stream.

7. The process of claim 6, wherein the evacuation gas stream is heated to a temperature higher than a dewpoint of the flue gas stream.

8. The process of claim 1, the CO₂ separation zone further providing an N₂ enriched stream, wherein the evacuation gas stream includes at least a portion of the N₂ enriched stream.

9. The process of claim 1, wherein the evacuation gas stream includes at least a portion of the CO₂ enriched stream.

10. The process of claim 1, further comprising drying the CO₂ enriched stream to remove H₂O and providing a dried CO₂ enriched stream, wherein the evacuation gas stream includes at least a portion of the dried CO₂ enriched stream.

11. The process of claim 1, wherein the evacuation gas stream is selected from a group consisting of CO₂, N₂, CO, O₂, H₂O (g), Ar, He, or a combination of any one or more of the foregoing.

12. A process for displacing particulates from low flow and small clearance areas in rotating equipment associated with a carbon capture unit, the process comprising:
compressing, in a compressor, a flue gas stream to provide a compressed flue gas stream;
sorbing, in a CO₂ separation zone including one or more vessels containing sorbent in a carbon capture unit, the compressed flue gas stream and providing a CO₂ enriched stream and an evacuation gas stream; and
introducing the evacuation gas stream to rotating equipment to displace any particulates in low flow and small clearance areas in the rotating equipment.

13. The process of claim 12, wherein the one or more vessels are distillation columns including solid adsorbent.

14. The process of claim 12, wherein the evacuation gas stream includes at least a portion of the CO₂ enriched stream.

15. The process of claim 12, wherein the evacuation gas stream is a CO₂ depleted stream or N₂ enriched stream.

16. The process of claim 12, wherein the one or more vessels are stripper columns regenerating solvent.

17. The process of claim 12, wherein the rotating equipment is selected from a group consisting of a compressor, an expander, or a combination of any one or more of the foregoing.

18. A process for displacing particulates from low flow and small clearance areas in rotating equipment associated with a carbon capture unit, the process comprising:
compressing, in a compressor, a flue gas stream to provide a compressed flue gas stream;
processing, in a membrane-based CO₂ separation zone including one or more membranes in a carbon capture unit, the compressed flue gas stream and providing a CO₂ enriched permeate stream and an evacuation gas stream; and
introducing the evacuation gas stream to rotating equipment to displace any particulates in low flow and small clearance areas in the rotating equipment.

19. The process of claim 18, wherein the evacuation gas stream includes at least a portion of the CO₂ enriched permeate stream.

20. The process of claim 18, wherein the rotating equipment is selected from a group consisting of a compressor, an expander, or a combination of any one or more of the foregoing.
